(19) United States
(12) Patent Application Publication
(10) Pub. No.: US 2024/0409842 A1
(43) Pub. Date: Dec. 12, 2024

(54) REMOVAL OF METALS AND INORGANICS FROM RENDERED FAT USING POLYAMINE-MODIFIED CELLULOSE NANOCRYSTALS

(71) Applicant: CLEMSON UNIVERSITY, CLEMSON, SC (US)

(72) Inventors: Daniel C. Whitehead, CLEMSON, SC (US); Carlos D. Garcia, CLEMSON, SC (US); Ezequiel Martin Vidal, BUENOS AIRES (AR)

(21) Appl. No.: 18/734,086

(22) Filed: Jun. 5, 2024

Related U.S. Application Data
(60) Provisional application No. 63/506,395, filed on Jun. 6, 2023.

(51) Int. Cl. C11B 3/10; B01J 20/24

(52) U.S. Cl. CPC C11B 3/10; B01J 20/24

(57) ABSTRACT

Methods and compositions are described that are useful for the refinement of animal or plant based fats or oils, such as rendered animal fats or used cooking oils. The methods can be utilized to remove metal and inorganic contaminants from the fats or oils. Refined products of the methods can be used to produce biodiesel that is compliant with ASTM B6751 for B100, and D7467 for B6 to B20.

### CROSS REFERENCE TO RELATED APPLICATION

This application claims filing benefit of U.S. Provisional Patent Application Ser. No. 63/506,395 having a filing date of Jun. 6, 2023, which is incorporated herein by reference for all purposes.

### FEDERAL RESEARCH STATEMENT

This invention was made with Government support under Contract No. 1P20GM146584-01, awarded by the NIH NIGMS. The Government has certain rights in the invention.

### BACKGROUND

Farms, feedlots, and meat-packing operations produce enormous amounts of animal byproducts not typically consumed by humans that are processed by the rendering industry. In North America alone, more than 62 billion pounds of renderable raw material including offal, bones, fat, blood, feathers, and dead-stock animals are produced annually. These materials are collected and transported as aggregated byproducts, which are then typically processed in rendering plants, leading to various rendered products that re-enter the industrial cycle as meat byproducts, various protein meals, and rendered animal fats.

The production of biodiesel from rendered materials typically involves the generation of fatty acid esters (transesterification) from triglycerides by means of homogeneous, heterogeneous, or enzymatic catalysis. Although various sources of triglycerides can be used to produce biodiesel, the diverse composition of the source material (and the presence of free fatty acids) imposes great challenges in terms of compliance with the standards from the American Society for Testing and Materials (ASTM B6751 for B100, and D7467 for B6 to B20). Particularly in the case of rendered materials from animal by-products or plant oils or fats, contamination with metal ions and complexes can present an issue.

### SUMMARY

The present disclosure is directed in one embodiment to methods for refining fats or oils from renewable sources, such as rendered animal fat or plant-based fats or oils. The method generally includes contacting a plant or animal based fat or oil that is contaminated with a metal or inorganic contaminant with a polyamine modified cellulose nanocrystal (CNC). Following a period of contact time, the polyamine functionalized CNC, now carrying the metal or inorganic contaminant, can be separated from the fat or oil.

Also disclosed is a method for the removal of a metal from a rendered animal fat. A method can include contacting the rendered animal fat with a polyethyleneimine-modified cellulose nanocrystal (PEI-CNC) for a period of time. Following the period of time, the method can include separating the rendered animal fat from the PEI-CNC.

Upon the separation, the metal can now be associated with the PEI-CNC and thus removed from the rendered animal fat.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is a reaction diagram showing (2,2,6,6-tetramethylpiperidin-1-yl)oxidanyl (TEMPO) oxidation of cellulose nanocrystals.

FIG. 2 is a reaction diagram showing the coupling of PEI to cellulose nanocrystals with N-(3-dimethylaminopropyl)-N′-ethylcarbodiimide hydrochloride (EDC).

FIG. 3 is a reaction diagram showing the coupling of PEI to cellulose nanocrystals with carbonyl diimidazole (CDI).

FIG. 4A is a bar chart showing the effectiveness of various sorbents (or lack thereof) at removing metallic/inorganic species from spiked canola oil.

FIG. 4B is a bar chart showing the effectiveness of various masses of CNC-PEI for a constant sample volume at removing metallic/inorganic species from spiked canola oil.

FIG. 5 is a bar chart showing the effectiveness of H₂O, CNC-PEI AND CNC-PEI/H₂O at removing metallic/inorganic species from spiked canola oil.

FIG. 6 is a bar chart depicting the removal % of analytes for varying sample temperatures.

FIG. 7A is a graph depicting the % content of spiked metallic/organic species remaining for a given duration water wash.

FIG. 7B is a graph depicting the removal % of metallic/inorganic species relative to the duration of time the sample is treated with CNC-PEI.

FIG. 8 is a table showing the percent reduction of various analytes and averages for samples 1-9.

FIG. 9 is a continuation of FIG. 4 with respect to samples 10-13.

FIG. 10 is a continuation of FIG. 5 with respect to samples 14-21.

FIG. 11 is a continuation of FIG. 6 with respect to samples 22-28.

FIG. 12A is a graph depicting the removal % of magnesium relative to the length of time the sample is treated with CNC-PEI.

FIG. 12B is a graph depicting the removal % of phosphorus relative to the length of time the sample is treated with CNC-PEI.

FIG. 12C is a graph depicting the removal % of iron relative to the length of time the sample is treated with CNC-PEI.

FIG. 12D is a graph depicting the removal % of potassium relative to the length of time the sample is treated with CNC-PEI.

FIG. 13A is a graph depicting the removal % of sodium relative to the length of time the sample is treated with CNC-PEI.

FIG. 13B is a graph depicting the removal % of sulfur relative to the length of time the sample is treated with CNC-PEI.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 5 percent margin, i.e., including values within five percent greater or less than the stated value.

To address the above issues, the present disclosure describes the use of polyamine-modified cellulose nanocrystals, e.g., polyethyleneimine modified cellulose nanocrystals (PEI-CNC), for the removal of various metallic cations (i.e. sodium, potassium, iron, calcium, magnesium) as well as sulfur and phosphorus inorganic contaminants, from fats or oils obtained from renewable resources. The polyamine CNC material can feature high surface area, great versatility towards chemical modifications, and low cost. As described in further detail herein, the effectiveness of the process has been assessed by inductively coupled plasma (ICP) with optical emission spectrometry (OES) detection under various experimental conditions. The inventors have found that polyamine modified CNC treatment of animal or plant based fats or oils can effectively remove about 90% by weight or greater of metal and inorganic contaminants present in the materials, such as about 95% by weight or greater in some embodiments, such as from about 93% to about 97% by weight in some embodiments, thereby providing a reasonable option to purify such materials, e.g., rendered fats or used cooking oil, to reduce metal/inorganic contamination. The successful application of this approach can offer the potential to purify renewable materials prior to use as biofuel feedstocks in one embodiment. For instance, refined oils and fats of disclosed methods can be utilized in one embodiment to produce biodiesel that is compliant with ASTM B6751 for B100, and D7467 for B6 to B20. The removal of undesirable metallic/inorganic contaminants from such materials, e.g., rendered fat in one particular embodiment, can also benefit their application in livestock feed and pet food formulations, among other useful applications.

Suitable fats or oils for the purposes of the present disclosure can include fats or oils that are derived from natural sources. For instance, fats or oils that are derived from natural sources can include rendered animal fats including, but not limited to, white grease, lard, chicken fat, fish oil, and beef tallow, including such oils and fats recovered from rendering wastewater treatment processes such as, but not limited to, Dissolved Air Flotation (DAF) sludge.

Alternatively, a wide variety of plant based materials may be used in accordance with the present disclosure. For instance, suitable plant based materials can include fats or oils derived from soy, castor, palm, peanut, rapeseed, sesame, canola and corn. Additionally, suitable oils can be reused and/or recycled cooking oils, such as used vegetable oil.

While the above provides examples of specific fats or oils that are suitable for use in the present method, one of skill will recognize that the method can be used for a wide variety of common fats and oils that are derived from renewable sources.

While the traditional destination of animal fats was the production of lard, soaps, oleochemicals, and animal feed/food formulations, the current market has also allowed their application as a source for renewable fuels including renewable diesel and biodiesel, an option that not only reduces the use of fossil fuels but also contributes to solving a waste management problem. In this regard, the production of renewable fuels from rendered fat and used cooking oil is presented as an economically attractive application of disclosed technologies, due to the low cost of the feedstock (that represents 75-90% of the overall cost of production) and high value of the final product. Moreover, fuel produced from sources such as rendered animal fats and used cooking oil typically presents a better emissions profile than that of other sources and does not affect food cost. Moreover, due to international socio-political considerations and the scarcity of natural gas, biodiesel has gained importance as a fuel source for the generation of electricity and heat.

Disclosed methods can utilize cellulose nanocrystals (CNC) that have been modified with an amine-bearing polymer. The polymer can be a polyalkyleneimine. As an example of an amine-bearing polyalkyleneimine, polyethyleneimine (PEI) is suitable for the purposes of the present disclosure. However, said amine-bearing polyalkyleneimine may be understood to include other polyalkyleneimines such as polypropyleneimine as well as branched or linear versions of a polyalkyleneimine.

CNC may be modified with an amine-bearing polymers through a linkage. The specific linkage that is used between the CNC and an amine-bearing polymer is not particularly limited and CNC may be coupled to a polyalkyleneimine by a variety of linkages. In some embodiments, the linkages may comprise ethers, esters, amides, amines, urea or carbamate linkages. In one embodiment, and without limitation, a polyalkyleneimine may be coupled to CNC using N-(3-dimethylaminopropyl)-N′-ethylcarbodiimide hydrochloride (EDC), carbonyl diimidazole, bromoacetyl bromide or bromoacetyl chloride.

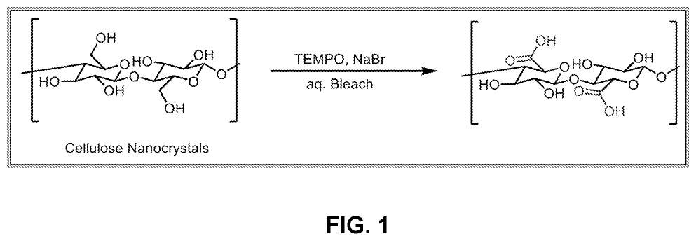

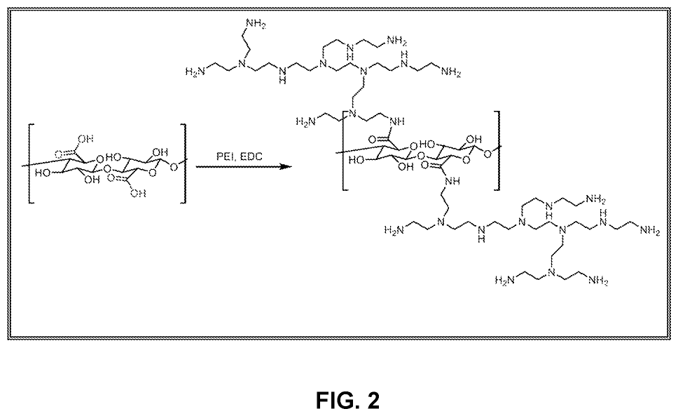

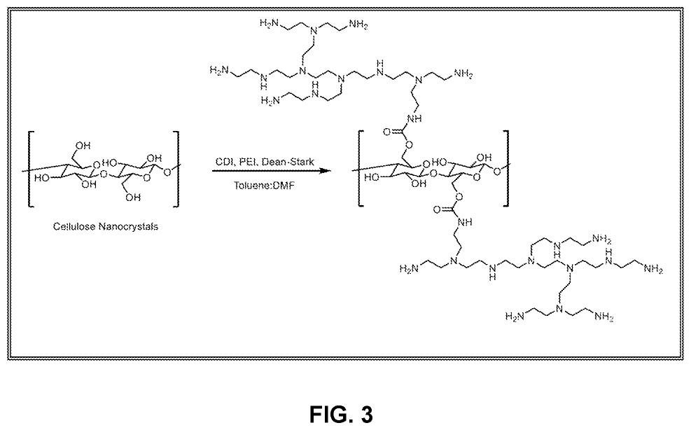

In forming a CNC material, CNC can initially be oxidized, for example by TEMPO oxidation, shown in FIG. 1. Thereafter, a coupling agent can be used to couple the desired polymer, e.g., polyethyleneimine, to the oxidized cellulose nanocrystals. For instance, 1-ethyl-3-(−3-dimethylaminopropyl) carbodiimide hydrochloride (EDC) may be used. Alternatively, carbonyl diimidazole, bromoacetyl bromide or bromoacetyl chloride may be used, as previously mentioned. Depending on the coupling agent used, the linkage between the cellulose nanocrystals and the polymer may vary. For instance, as is shown in FIG. 2, wherein EDC is used as a coupling agent, amides are present in the linkages between the cellulose nanocrystals and the polymer. Alternatively, as can be found in FIG. 3, wherein carbonyl diimidazole is used as the coupling agent, carbamate groups may form the linking group. As stated above, however, the linkage used in the present disclosure is not particularly limited and does not place particular limitations on the scope of the present method.

As a non-limiting example of the method described herein, CNC-PEI can be combined with an amount of a fat. The fat and CNC-PEI can undergo agitation during contact. Following a period of time, e.g., greater than 1 minute, such as greater than 4 minutes, such as greater 8 minutes, such as greater than 10 minutes, such as greater than 15 minutes, such as greater than 30 minutes, the CNC-PEI can be separated from the fat, with metal/inorganic contaminants of the fat separated therefrom in conjunction with the CNC/PEI.

While the method for separation of the CNC-PEI from the fat is not particularly limited, some exemplary methods include filtration, centrifugation, chemical treatment, settling or heating.

In some embodiments, prior to a step of adding CNC-PEI to the fat, the method can include washing the fat with water. Doing so may reduce the concentration of metallic ions in the fat that is subsequently contacted with the CNC/PEI. Additionally, washing the fat can remove large-sized contaminants, e.g., large particles of dirt or other large contaminants. Generally, the water can be removed from the fat prior to the contact with the CNC-PEI.

Metallic/inorganic species as may be separated from a plant or animal based fat or oil according to disclosed methods can include, but are not limited to, Ca, Fe, K, Mg, and Na and various oxidation states thereof. In addition, the method described herein may also be useful to remove inorganic contaminants including phosphorus and sulfur from a plant or animal based fat or oil.

The cellulose source of the CNC used in a method is not particularly limited. By way of example, and without limitation, CNC for use as described herein may be derived from cotton bolls, ginned cotton, or any other readily available source of cellulose. CNC can be obtained from retail sources as would be known to one of skill in the art or formed, generally by the acid hydrolysis of native cellulose using an aqueous inorganic acid like sulfuric acid. Upon the completion (or near completion) of acid hydrolysis of the amorphous sections of native cellulose, individual high aspect ratio rod like crystallites (CNC) are obtained that are dispersible in a reaction medium. CNC possesses excellent mechanical properties, biodegradability, and biocompatibility. CNC generally have a diameter in the range of about 10 to about 20 nm and length of a few hundred nanometers (e.g., about 50 nm to about 500 nm). CNC can also have a high surface area, e.g., about 500 m²/g.

In one embodiment of the present disclosure, the mass of modified CNC may be in proportion to the mass of the fat or oil to be refined. As a non-limiting example, the mass of the CNC treatment material may be from about 0.5 wt. % to about 10 wt. % based on the mass of the fat or oil. In another embodiment, the mass of the CNC treatment material may be from about 1 wt. % to about 5 wt. % based on the mass of the fat or oil. In another embodiment, the mass of the CNC treatment material may be from about 2.5 wt. % to about 4.5 wt. % based on the mass of the fat or oil. In another embodiment, the mass of the CNC treatment material may be from about 2.8 wt. % to about 3.5 wt. % based on the mass of the fat or oil.

In one embodiment, contact between the CNC treatment material and the fat or oil being refined may be carried out a temperature that is about 40° C. or greater, such as about 60° C. or greater, such as about 80° C. or greater, such as about 100° C. or greater. Additionally, contact between the CNC treatment material and the fat or oil being refined may be carried out at a temperature that is about 100° C. or less, such as about 80° C. or less, such as about 60° C. or less, such as about 40° C. or less. In some embodiments, the temperature may be about 60° C.

As will be seen in the following examples, through the disclosed methods, it is possible to remove about 60% by weight or greater of metallic/inorganic species present in the fat or oil to be treated, such as about 70 wt. % or greater, about 80 wt. % or greater, or about 90 wt. % or greater in some embodiments.

While the specifics of the above methods may vary, as will be shown in the following examples, removal of metallic ions can be achieved.

### Example 1

The effectiveness of the process was assessed by inductively coupled plasma (ICP) with optical emission spectrometry (OES) detection under various experimental conditions. Below in Table 1 is summary analytical data regarding the method of ICP-OES with respect to specific metallic analytes.

| | Range | Wavelength | Sensitivity | LOD | LOQ |
|---|---|---|---|---|---|
| Element | (mg/L) | (nm) | (mg/L/IAU) | (mg/L) | (mg/L) |
| Na | 0.2-155 | 588.995 | 786.4 | 0.2 | 0.6 |
| K | 0.2-155 | 766.490 | 207.5 | 0.3 | 0.9 |
| Ca | 0.2-155 | 393.366 | 15312 | * | 0.2 |
| Mg | 0.1-142 | 280.270 | 3685 | * | 0.0 |
| Fe | 0.1-155 | 259.940 | 182 | 0.1 | 0.2 |
| P | 0.1-105 | 177.495 | 12.5 | * | 0.1 |
| S | 0.1-270 | 180.731 | 12.3 | 0.2 | 0.6 |

A model system based on spiked canola oil was used to analyze the effect of sorbents on the efficiency of the removal process. For these experiments a sample of canola oil was fortified with CaCl₂, FeSO₄, KNO₃, MgSO₄, NaCl, and Na₂HPO₄ by adding aliquots of concentrated aqueous solutions. This solution was then maintained at 60° C. under continuous stirring for approximately 48 h to evaporate the water and ensure adequate dispersion of the metallic cations in the oil. These samples were then used to investigate the performance of the sorbent materials. To this end, two CNC materials were tested and compared: unmodified CNC (featuring —OH functional groups) and poly(ethylenimine)-modified CNC (PEI-CNC, featuring —NH₂ functional groups on the surface). The latter is especially important considering that the addition of the polyethyleneimine groups can enhance the adsorptive characteristics of these materials. The resulting primary and secondary amino groups would have the ability to be electron donors, allowing the formation of a coordination complex with the metal ions in the sample. Also, the porous structure of the CNC-PEI would facilitate the diffusion of the ions while increasing the adsorption surface area.

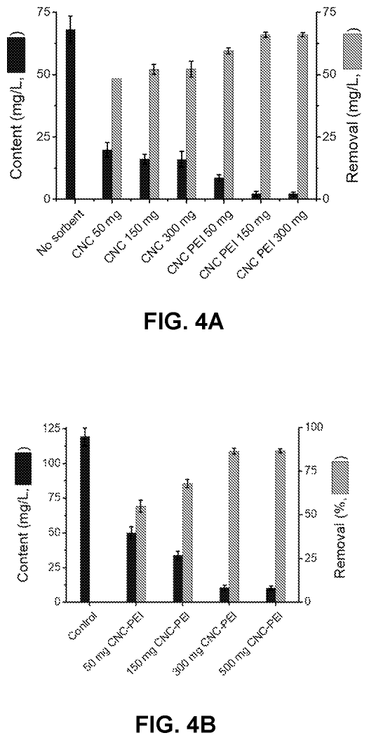

To compare the performance of both sorbents and determine the optimum amount needed for the extraction, both materials (CNC and CNC-PEI) were applied to the same model matrix using different sorbent quantities. Three amounts of sorbents were tested: 50 mg, 150 mg and 300 mg per 10 mL of spiked canola oil. As it can be observed, a significant reduction in the content of the metallic cations was observed (FIG. 4A, black columns). In all cases, the use of CNC-PEI allowed extracting significantly higher amounts (66.0±0.7, at 150 mg) of metals/inorganics as compared to unmodified nanocrystals (52.1±0.6, also at 150 mg).

Upon demonstrating that the overall extraction capacity of CNC-PEI was superior to that of CNC, studies were carried out to optimize the amount of CNC-PEI needed to address authentic samples of rendered fat. With that purpose, the effect of different quantities of CNC-PEI over the range of 50 to 500 mg on the extraction capacity was investigated using a sample of rendered poultry fat. For this purpose, a control sample was not treated with CNC-PEI, and four more samples from the same lot were treated with 50, 150, 300, and 500 mg of CNC-PEI, respectively. The results, summarized in FIG. 4B, show that removal improved with the mass of CNC-PEI added up to 300 mg (reaching a 92% removal), above which no additional improvements in removal were evident.

### Example 2

Aiming to demonstrate the broad applicability of the present method, rendered fat samples were obtained from multiple rendering plants around United States. Participating plants contributed samples of rendered chicken fat, various grades of beef tallow, choice white grease (pork), and used cooking oil. The chemical and organoleptic characteristics of individual samples were extremely variable, but all of them presented significant amounts of solid residues. Thus, an additional washing step was explored to clean the samples before treating them with CNC-PEI.

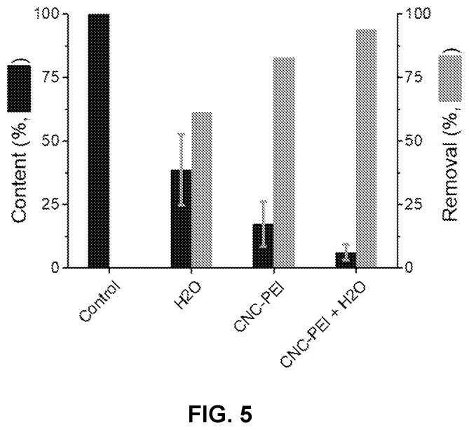

The proposed step was carried out with distilled water, pre-heated at 60° C., to avoid solidification of the sample and negatively impact the contact surface for the proposed extraction. It was hypothesized that some of the free ionic species could be removed with the water wash enhancing the results of the overall procedure. For this reason, a comparison between water-washed, CNC-PEI treated, and a sequential extraction with water followed by CNC-PEI) was performed. Spiked canola oil was used as a model sample and three different approaches were evaluated: a water wash, CNC-PEI extraction, and a combination of a water wash followed by a CNC-PEI extraction (FIG. 5). Thus one 10 mL spiked canola oil sample was washed with 10 mL of water (60° C.), another one was treated with 300 mg CNC-PEI, and a third sample was first washed with 10 mL of water and then the oil layer was separated and treated with 300 mg CNC-PEI. According to our results, the inclusion of a water wash resulted in a significant reduction of ions (61±4%) and the clarification of the sample (FIG. 5). The results also confirmed that treatment with CNC-PEI as removal agent outperformed a water wash (82±4%, overall removal of the metallic cations). This also confirmed that not all undesired elements were forming polar ions. Combining both strategies lead to a better remediation of the rendered fat sample with a 94±4% overall removal of the metallic cations. In this way it was demonstrated that a 10-minute wash (1:1 sample:water) at 60° C. significantly enhanced the removal of the metals/inorganics from rendered fat samples.

### Example 3

Along the rendering process in plants, fat is melted, degummed, neutralized, and sometimes bleached in order to simplify any further treatment. The general procedure in a regular factory regardless of the rendering method involves a heating step to release the fat from fat cells and to melt the mixture. Studying how temperature affects the CNC-PEI removal of analytes is crucial to optimize the extraction process.

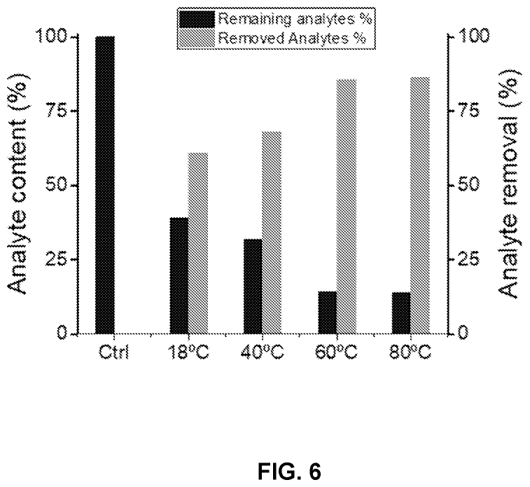

The functionality of CNC-PEI for removing metals/inorganics was investigated at different temperatures, using spiked canola oil as a model sample. By using oil, the possibility of solidification of the rendered fat influencing the results of the study was avoided. The control for this test was a spiked canola oil sample processed at room temperature (18° C.). 10 mL aliquots of the spiked sample were heated at different temperatures and then they were extracted with 300 mg CNC-PEI, centrifuged, and measured. Results (FIG. 6) showed that the removal of analytes (total content) is dependent on the temperature, where increases in the temperature led to better extraction efficiencies, reaching a maximum at 60° C. Further increases in the temperature (up to 80° C.) did not provide additional improvements. Without wishing to be limited by theory, this behavior can be explained considering the decrease in the viscosity of the medium, which favors the interaction between the target species and the sorbent. An additional advantage of these findings is that the optimum temperature for the extraction coincides with the temperature required for the transesterification and degumming processes, probably for similar reasons.

### Example 4

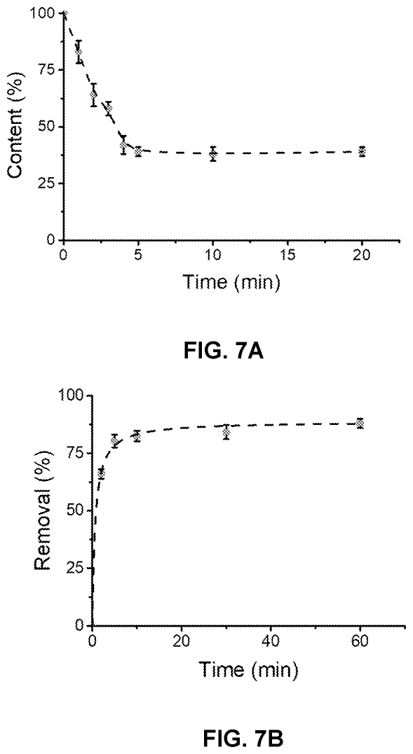

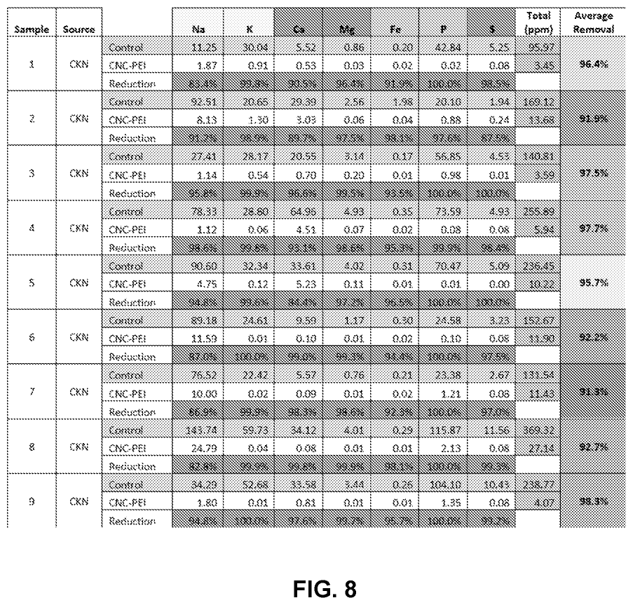

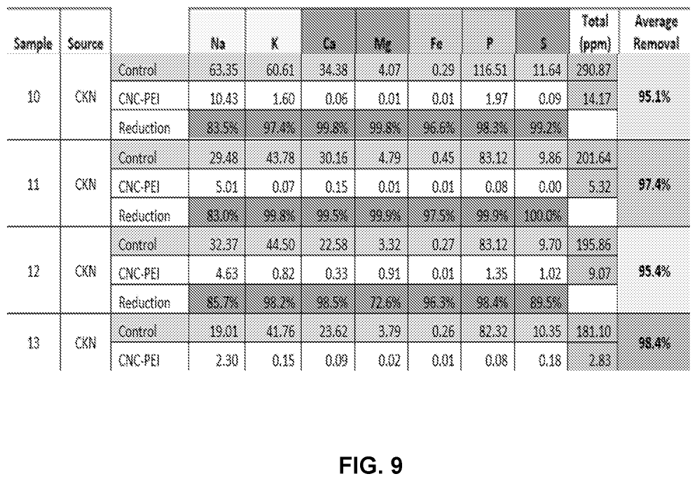

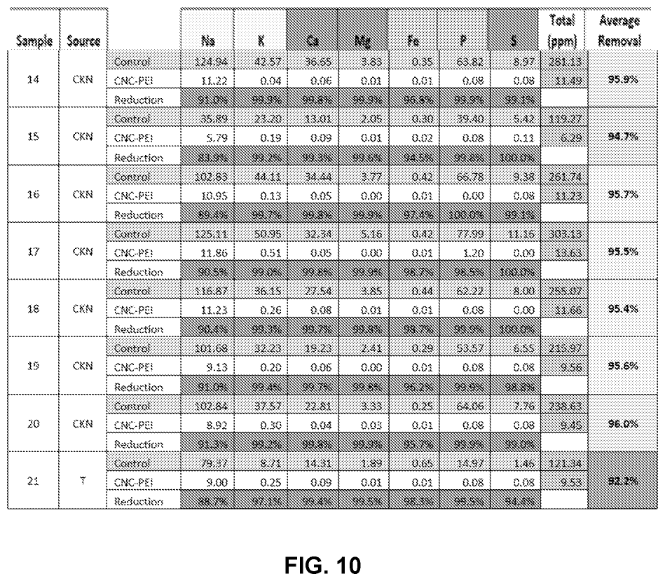

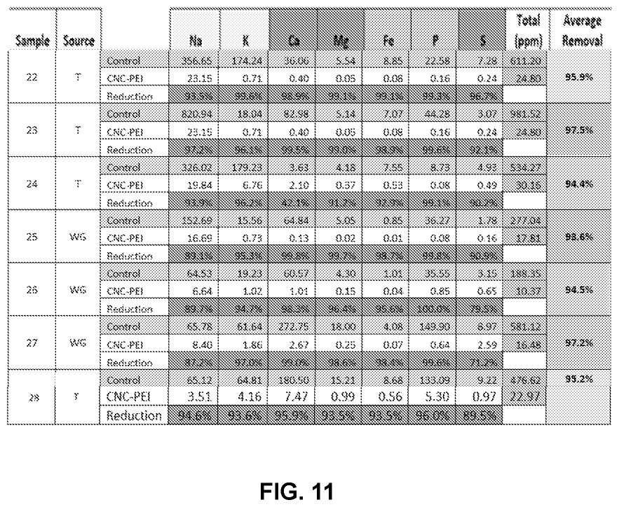

Once it was demonstrated that a water washing step (with vortexing) would enhance the removal of metals/inorganics, the duration of that process was optimized. Considering that the process would be ultimately applied to rendered fat samples, both the water and the sample of canola oil were heated at 60° C. Spiked canola oil samples were extracted with water at different times and quantified. It was observed that the overall extraction of metallic species increased rapidly during the first few minutes but reached a plateau at approximately 4 min (FIGS. 7A and 7B). Additional experiments are currently underway to determine the kinetic parameters of the interaction but considering that no further improvements were obtained within the selected timeframe (<20 min), a 5-min washing step was added to the process. Once the extraction with warm water was completed, the samples were allowed to stand for 5 min, to separate the phases adequately. It is also important to note that the moisture level in the treated fat samples does not increase after the water-wash procedure. Specifically, the moisture levels were obtained for tallow before (0.51±0.07%) and after the water treatment (0.52±0.08%), not showing statistically significant differences (t-test, t_{crit}=2.77 and tₛₜₐₜ=0.20).

### Example 5

The extraction time with CNC-PEI was studied to obtain a compromise between the best extraction and the fastest procedure. Spiked canola oil control samples were used with 300 mg of CNC-PEI sorbent contact time was investigated over different periods of time. Once the desired time was over, falcon tubes were centrifuged for 2 min (9000 rpm). The upper layer was separated and analyzed to determine the total content of metallic/inorganic analytes. An untreated oil sample was analyzed as a control and a sample that was centrifuged for 2 min immediately after CNC-PEI addition was taken as time 0. Results were plotted as extraction percentage as a function of contact time and fitted. FIGS. 7A and 7B show the extraction rate for calcium. The reaction proceeds rather quickly, reaching 82±3% of the extraction within the first 5 minutes of contact. Additional contact time (up to 60 min) only produced slight additional enhancements, leading to a maximum extraction of 87±3%, during the selected experimental window. In order to further understand this behavior and support the hypothesis that this reaction is determined by the adsorption process where the adsorption efficiency is determined by the adsorption capacity of the CNC-PEI, and not by the concentration of the analytes, removal kinetic studies were carried on.

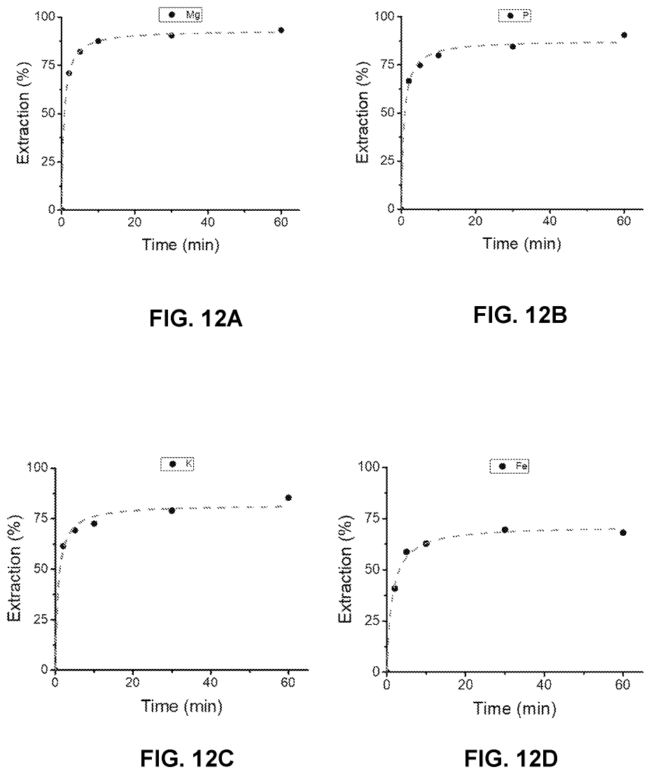

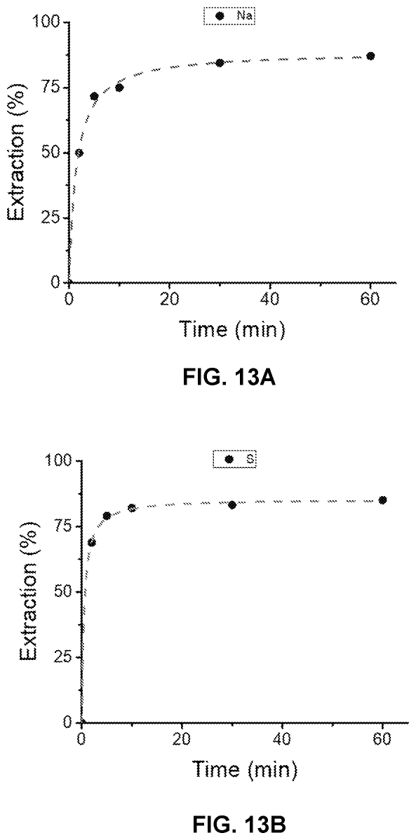

Experimental results obtained for calcium were fitted against a pseudo-first order kinetics and a pseudo-second order kinetics with nonlinear regression to analyze kinetic mechanism. A pseudo-second-order model showed a R²=0.9996, against a 0.9923 obtained with a pseudo-first order fitting. These results suggest that a pseudo-second-order kinetics is taking place, depending on adsorption capacity of CNC-PEI and being independent from adsorbate concentration. This same behavior has been reported in other oily viscous matrices. The same procedure was applied to the rest of the analytes showing identical results (FIGS. 12A-13B).

### Example 6

Twenty-eight rendered fat samples from different plants in the USA were collected and analyzed individually. The origin of the samples was diverse including beef tallow, choice white grease (pork), and poultry rendered fat. Samples (10 mL) were treated with a 1:1 water wash, followed by 500 mg of CNC-PEI. The detailed metal/inorganic composition for every sample was determined in order to show the removal of individual species. The initial content of analytes in every sample was taken as the control for each treatment. The degree of metal and inorganic contamination varied considerably between samples. In all cases, the extent of metal/inorganic removal is above 91%, showing that the proposed remediation strategy is not only versatile in terms of sample origin but also slightly superior than strategies reported for other ions. The final concentration of the analyzed species was greatly decreased, even in samples with very high concentration of such analytes. In most of the samples, the final concentration of Ca/Mg and Na/K is reduced below ASTM standards requirements. The initial total analyte concentration in samples ranged from 100 to 1000 ppm demonstrating a wide working range without decreased efficacy. The treatment results showed that the proposed method could be used in different rendered fat samples (i.e. poultry, white pork grease, or beef tallow), having outstanding removal rates for all samples. Aggregated results from the entire set of samples showed that the proposed treatment reaches up to 95±2% removal of total metal/inorganic contaminants.

While certain embodiments of the disclosed subject matter have been described using specific terms, such description is for illustrative purposes only, and it is to be understood that changes and variations may be made without departing from the spirit or scope of the subject matter.

What is claimed is:

1. A method for refining an animal or plant-based fat or oil comprising:
contacting for a period of time an animal or plant based fat or oil that is contaminated with a metal or inorganic contaminant with a polyamine-modified cellulose nanocrystal;
and following the period of time, separating the polyamine-modified cellulose nanocrystal from the fat or oil, wherein upon the separation, the metal or inorganic contaminant is associated with the polyamine-modified cellulose nanocrystal and thus removed from the fat or oil.

2. The method of claim 1, further comprising washing the fat or oil with water prior to contacting the fat or oil with the polyamine-modified cellulose nanocrystal.

3. The method of claim 1, wherein the polyamine-modified cellulose nanocrystal is contacted with the fat or oil at a concentration of from about 1 wt. % to about 10 wt. % by weight of the fat or oil.

4. The method of claim 1, wherein the polyamine-modified cellulose nanocrystal is contacted with the fat or oil at a concentration of from about 2.5 wt. % to about 4.5 wt. % by weight of the fat or oil.

5. The method of claim 1, wherein the polyamine-modified cellulose nanocrystal comprises polyethyleneimine modified cellulose nanocrystal.

6. The method of claim 5, wherein the polyamine-modified cellulose nanocrystal comprises polyethyleneimine coupled to the cellulose nanocrystal by a linkage selected from the group consisting of an amide linkage, ester linkage, ether linkage, urea linkage and carbamate linkage, or any combination thereof.

7. The method of claim 1, wherein the period of time is about 10 minutes or less.

8. The method of claim 1, wherein the fat or oil comprises an animal fat.

9. The method of claim 8, wherein the animal fat comprises beef tallow, white grease, fish oil or chicken fat.

10. The method of claim 1, wherein the fat or oil comprises a plant-based oil.

11. The method of claim 10, wherein the plant-based oil comprises used cooking oil.

12. The method of claim 1, further comprising washing the fat or oil with water following separation of the polyamine-modified cellulose nanocrystal from the fat or oil.

13. The method of claim 1, wherein the contact is carried out at a temperature of about 80° C. or less.

14. The method of claim 1, wherein the cellulose nanocrystal is derived from cotton bolls or ginned cotton.

15. A method for the removal of a metal from a rendered animal fat comprising:
contacting the rendered animal fat with a polyethyleneimine-modified cellulose nanocrystal for a period of time, wherein the rendered animal fat comprises the metal; and
following the period of time, separating the rendered animal fat from the polyethyleneimine-modified cellulose nanocrystal, wherein upon the separation, the metal is associated with the polyethyleneimine-modified cellulose nanocrystal and thus removed from the rendered animal fat.

16. The method of claim 15, further comprising washing the rendered animal fat with water prior to the step of contacting the rendered animal fat with the polyethyleneimine-modified cellulose nanocrystal.

17. The method of claim 15, wherein the polyethyleneimine-modified cellulose nanocrystal is contacted with the rendered animal fat in an amount from about 1 wt. % to about 10 wt. % by weight of the rendered animal fat.

18. The method of claim 15, wherein the metal removed from the rendered animal fat is about 90% or more of total metal of the rendered animal fat prior to the contact.

19. The method of claim 15, wherein the metal comprises potassium, iron, calcium, magnesium or sodium, or any combination thereof.
